(19) United States
(12) Patent Application Publication
(10) Pub. No.: US 2023/0322587 A1
(43) Pub. Date: Oct. 12, 2023

(54) ELECTRODIALYSIS AND ELECTRODEIONIZATION SPACERS

(71) Applicant: IONIC SOLUTIONS LTD., Rancho Mirage, CA (US)

(72) Inventor: Azaroghly YAZDANBOD, Calgary (CA)

(21) Appl. No.: 18/132,379

(22) Filed: Apr. 8, 2023

Related U.S. Application Data
(60) Provisional application No. 63/328,950, filed on Apr. 8, 2022.

(51) Int. Cl. C02F 1/461; C02F 1/469

(52) U.S. Cl. CPC C02F 1/46104; C02F 1/4695; C02F 1/4693

(57) ABSTRACT

An improved spacer and a process for the manufacture thereof for use in electrodialysis and electrodeionization stacks. The spacer can provide reduced leakage and improved sealing between stack compartments, as well as reduced output product loss and reduced energy consumption per unit volume of output product.

### CROSS REFERENCES TO RELATED APPLICATION

The present application claims the benefit of U.S. Provisional Application No. 63/328,950 filed Apr. 8, 2022, the entire disclosure of which is hereby incorporated by reference.

### FIELD OF THE INVENTION

The present invention relates in general to electrodialysis and electrodeionization systems for desalination, decontamination, softening and deionization of water, and in particular to spacers for use in electrodialysis/electrodeionization stacks which provide improved sealing between stack compartments, reduced output product loss from leakage, and reduced energy consumption per unit volume of output product.

### BACKGROUND OF THE INVENTION

Devices employed for removal of dissolved ions from electrolyte solutions using electric fields include electrodialysis and electrodeionization devices. Such devices can be used for desalination of saltwater, softening hard waters, deionization of low conductivity waters, and removal of ionic contaminants from solutions containing such ions.

Electrodialysis systems are typically used for input solutions having a high salt content, for example 1000 mg/liter and higher, such as brackish water and seawater, to produce water for human consumption. In contrast, electrodeionization devices are typically used for production of higher purity products from higher purity feeds, such that the input solutions already have a low salt content and have typically already passed through one or more reverse osmosis systems. Further, while electrodialysis devices typically use rather thin spacers made of a plastic mesh, electrodeionization systems typically incorporate specific, voluminous spacers which are filled with electroactive media such as ion exchange resin beads to facilitate ion flow.

A typical electrodialysis/electrodeionization cell includes the combination of a pair of electrodes each housed in an endplate, a “stack” in between the two endplates, a DC power supply, input fluid flow channels/passages, and output fluid flow channels/passages. A stack is a series of multiple paired chambers, typically arranged into a configuration of alternating anion-selective and cation-selective ion exchange membranes, separated from one another by spacers positioned between adjacent membranes. Diluted or “dilute” compartments alternate between the ion exchange membranes with concentrated or “concentrate” compartments, and these compartments are formed over time by the action of a direct current (DC) electric field transversely passing through the solution filling the volumes between ion exchange membranes. Ions are accumulated in the concentrate compartments and removed from the dilute compartments.

Spacers are included in the stack in general to create working space between the ion exchange membranes, and they can also provide proper fluid flow and hydrodynamics. Starting with the endplates on each side of the stack, there is typically an “end spacer” which, together with the first ion selective membrane, isolates the electrodes located in the endplates from the feed solution passing through the stack, as well as from the product/dilute stream, and the concentrate stream. Alternatively, the electrodes housed in the endplates can be in contact with the feed solution. All of these components and their functions are well-known in the art, and are also described below.

In both electrodialysis and electrodeionization cells, the “input” or “feed” electrolyte solution is directed through specific flow channels, usually positioned in the endplates. These flow channels work in combination with flow passages in the ion selective membranes and spacers to enable the independent flow of liquids in the concentrate and dilute compartments. Ions present in the feed solution are subjected to an electric field, established through the stack by application of a DC electric potential difference between the electrodes. The passage of the DC current through the stack of alternating anion-selective and cation-selective membranes results in the formation of the alternating dilute and concentrate compartments, with ions being depleted from the liquid flowing through the dilute compartments and accumulated in the adjacent concentrate compartments.

The flow or conduction of ions in electrodialysis/electrodeionization stacks is governed by Ohms law (I=V/R). The electric current (I) of ions is directly proportional to the applied potential difference (voltage, V) and is inversely proportional to the electric resistance (R). Since electrodeionization cells typically involve the production of sparingly conductive waters and solutions such as high purity or ultrapure waters, the electric resistivity and resistance of these solutions is so high that the required voltages to establish a reasonable current can become quite excessive. Thus, typically electroactive media (ion exchange resins) are included in the spacers between the membranes to facilitate the flow of ions and define a low resistance path for flow of ions. The use of electroactive media such as ion exchange resins is generally not required in electrodialysis systems that treat high conductivity waters (such as brackish water or seawater) to produce potable water; rather, for these systems, the spacers are typically a mesh made up of woven strands of non-conductive materials such as plastics which allow for flow of water between the membranes. These spacers also typically have punched or cut-out holes with specific gasketed edges for prevention of leaks to the outside of the stack and between the stack compartments that also allow the independent flow of feed water into and out of the dilute compartments and the concentrate compartments, as is well known by the practitioners of this technology. Other functions of spacers in electrodialysis/electrodeionization systems include facilitation of the independent flow of the liquids in the dilute compartments and the concentrate compartments, structural support for the membranes, creation of volume and flow passages within each compartment, and maintenance of separation between adjacent anion-selective and cation-selective membranes.

Conventional electrodialysis/electrodeionization devices typically use conventional metallic electrodes for generation of the DC electric fields within the stack. In these electrodes, charges (electrons) are transferred across the metal-liquid interface. These electron transfers cause oxidation and/or reduction (redox) reactions to occur, depending on electrode polarity. Redox Reactions are governed by Faraday's law (i.e., the amount of chemical reaction products produced by the flow of current is proportional to the amount of electricity passed). Metallic electrodes thus establish electric fields within the solutions surrounding them via “Faraday/Redox” electrode reactions. If the potential difference between each electrode and the solution adjacent to it is less than the minimum potential to allow electrode reaction (charge exchange between the electrode and the ions in the solution adjacent to it) there will be no electric field between the electrodes, and no electric current will pass between the electrodes. Occurrence of Redox Reactions at metallic electrodes in water unavoidably also leads to generation of hydrogen gas at the cathode and oxygen gas at the anode. If the concentration of the chlorides in the solution adjacent to the anode is high, chlorine gas could also be generated.

In some electrodialysis devices the electrodes used are of the capacitive type, capable of absorbing large amounts of ions and capacitively establishing an electric field without the occurrence of electrode reactions. U.S. Pat. No. 10,329,174 to Yazdanbod, which is incorporated herein by reference in its entirety, specifically teaches the use of high electric capacitance electrodes such as electric double layer capacitor (EDLC) electrodes or supercapacitor electrodes, discusses the behavior of such high electric capacitance electrodes in confined containers, the use of high electric capacitance electrodes as means of capacitive generation of electric fields and ionic currents, and polarity reversals as a means of avoiding electrode reactions. The behavior of the stack and its function in creation of dilute compartments and the concentrate compartments is independent of how the electric field is generated. That is, the behavior and function of a given stack in response to the electric field passing through it is the same if the electric field is established by the use of metallic electrodes which function by occurrence of electrode Redox Reactions and generate gases or by capacitive electrodes which establish the electric field by absorption of ions, without electrode reactions. Thus, all the features of the stack and its modes of operation are applicable to cells using metallic or capacitive electrodes or any other means of establishing the electric field therein.

When high recovery of output product (e.g. product water) is the goal, then a higher proportion of the feed solution can be preferably “pushed”, for example via increased applied pressure through the dilute compartments than the concentrate compartments. However, such an increased pressure differential can put stress on the spacer's seals, causing leakage between the dilute compartments and the concentrate compartments. This leakage can reduce output product recovery, and can also lead to the waste of the energy used to produce the output product. To avoid, prevent or reduce leakage between the dilute compartments and the concentrate compartments, current electrodialysis systems on the market will require a limit on the differential pressure that is applied between the compartments, often to rather low values, such as a fraction of one bar. This small pressure differential is also intended to protect the ion exchange membranes from the development of large tension stresses, which could lead to tearing and puncturing of the membranes. Careful experimentation by the present inventor with gasketing patterns around water flow passages on a number of existing spacers has found that appreciable leaking from the dilute compartments to the concentrate compartments can be observed when an increasing differential pressure is applied, as is often desirable in order to achieve high recoveries. In addition, when the goal is to produce highly concentrated products, leakage of the dilute compartments into the concentrate compartments reduces the quality of the output product. The exact mechanism of this leaking phenomenon, and a proposed spacer for preventing it, is described herein.

In light of the above, it would be beneficial to provide a specific spacer for electrodialysis and electrodeionization systems which can prevent or resist leakage between the alternating dilute and concentrate compartments of the system, and can therefore allow for operation of these systems with large feed pressure differences between the dilute compartments and the concentrate compartments, and therefore with higher recoveries of output product such as desalinated water. It would also be beneficial to provide a specific spacer which can prevent and/or reduce leaks between the alternating dilute compartments and concentrate compartments of electrodialysis and electrodeionization systems in order to improve the efficiency of the system by preventing output product water wastage and/or decreased quality, and saving the energy used during the desalination and/or deionization process.

### SUMMARY OF THE INVENTION

Accordingly, the present invention teaches spacers for use in electrodialysis and electrodeionization system which can reduce or even prevent leakage between the dilute compartments and the concentrate compartments, and which can allow for differing feed pressures in the dilute compartments and the concentrate compartments while providing increased product recovery. The prevention of leakage by the inventive spacer also can prevent product water wastage, improve output product quality, and save energy consumption, thereby improving the efficiency of the system.

A first aspect of the invention provides a spacer for use in electrodialysis and electrodeionization systems, the spacer comprising: a plastic mesh sheet including a top end, a bottom end, a first side, and a second side; and a gasketing edge structurally connected to the plastic mesh sheet, the gasketing edge comprising: gasketing material applied to the outside perimeter of the first side and the second side of the plastic mesh sheet; and a plurality of water flow holes arranged within the gasketing edge at the top end and at the bottom end of the plastic mesh sheet; a central mesh area bounded by the gasketing edge, wherein a first half of the plurality of water flow holes are structurally and hydraulically connected to the central open area; a plurality of connecting flow paths structurally and hydraulically connecting the first half of the plurality of water flow holes to the central mesh area, wherein the thickness of the applied gasketing material is uniform on both the first side and the second side of the plastic mesh sheet so that the gasketing edge provides uniform compressive stress around the water flow holes, thereby preventing leakage.

A second aspect of the invention provides a process for the manufacture of a spacer for use in electrodialysis and electrodeionization systems, the spacer comprising: a plastic mesh sheet including a top end, a bottom end, a first side, and a second side; and a gasketing edge structurally connected to the plastic mesh sheet, the gasketing edge comprising: a gasketing material applied to the outside perimeter of the first side and the second side of the plastic mesh sheet; and a plurality of water flow holes arranged within the gasketing edge at the top end and at the bottom end of the plastic mesh sheet; a central mesh area bounded by the gasketing edge, wherein a first half of the plurality of water flow holes are structurally and hydraulically connected to the central mesh area; a plurality of connecting flow paths structurally and hydraulically connecting the first half of the plurality of water flow holes to the central mesh area, wherein the thickness of the applied gasketing material is uniform on both the first side and the second side of the plastic mesh sheet, the process comprising the steps of: (a) placing one of a first plurality of lengths of tape over the location of every other water flow hole at both the top end and the bottom end of the first side of the plastic mesh sheet; (b) applying the gasketing material to the outside perimeter of the first side of the plastic mesh sheet while not applying the gasketing material to the central mesh area; (c) curing the applied gasketing material to the first side of the plastic mesh sheet; (d) placing one of a second plurality of lengths of tape over the location of every other water flow hole at both the top end and the bottom end of the second side of the plastic mesh sheet, and at the same positions as the first plurality of lengths of tape placed on the first side of the plastic mesh sheet; (e) applying the gasketing material to the outside perimeter of the second side of the plastic mesh sheet while not applying the gasketing material to the central mesh area; (f) curing the applied gasketing material to the second side of the plastic mesh sheet; and (g) punching out the plurality of water flow holes.

A third aspect of the invention provides an improved spacer for preventing leakage between stack compartments in an electrodialysis or electrodeionization system, the system comprising: a stack of alternating pairs of ion exchange membranes, each ion exchange membrane creating a concentrate compartment on one side and a dilute compartment on the other side when the system is filled with a feed solution and acted upon by a direct current; a first electrode housed in a first endplate positioned on one side of the stack; a second electrode housed in a second endplate positioned on the other side of the stack; a plurality of input and output passages leading into and out of the endplates and the stack; and a direct current electric power supply for establishing a potential difference between the first electrode and the second electrode to cause the passage of electric current through the feed solution, wherein the improved spacer comprises: (a) a plastic mesh sheet including a top end, a bottom end, a first side, and a second side; and (b) a gasketing edge structurally connected to the plastic mesh sheet, the gasketing edge comprising: gasketing material applied to the outside perimeter of the first side and the second side of the plastic mesh sheet; and a plurality of water flow holes arranged within the gasketing edge at the top end and at the bottom end of the plastic mesh sheet; a central mesh area bounded by the gasketing edge, wherein a first half of the plurality of water flow holes are structurally and hydraulically connected to the central open area; a plurality of connecting flow paths structurally and hydraulically connecting the first half of the plurality of water flow holes to the central mesh area, wherein each pair of ion exchange membranes has the improved spacer positioned between the membranes, wherein the thickness of the applied gasketing material is uniform on both the first side and the second side of the plastic mesh sheet so that the gasketing edge provides uniform compressive stress around the water flow holes, thereby preventing leakage between the stack compartments, reducing output product loss from leakage, and reducing energy consumption per unit volume of output product.

The nature and advantages of the present invention will be more fully appreciated from the following drawings, detailed description, and claims.

### BRIEF DESCRIPTION OF THE DRAWINGS

The accompanying drawings illustrate the prior art and preferred embodiments of the invention and, together with a general description of the invention given above, and the detailed description given below, explain the principles of the invention.

FIG. 1 illustrates a typical ion selective membrane with water passage holes on it;

FIG. 2 illustrates a prior art spacer, in two orientations;

FIG. 3 illustrates an end spacer for a typical electrodialysis/electrodeionization system;

FIG. 4 is a schematic presentation of a typical electrodialysis/electrodeionization system;

FIG. 5 illustrates a typical pattern of water conveyance passages for endplates;

FIG. 6 shows locations of low contact stress areas on prior art spacers;

FIG. 7 illustrates an improved spacer for electrodialysis and electrodeionization cells.

### DETAILED DESCRIPTION OF THE INVENTION

The present invention improves on the prior art spacers used in electrodialysis and electrodeionization systems through the prevention of leakage of output product (e.g. purified water) from the dilute/product compartments to the concentrate compartments. The inventive spacer embodiments described herein can also prevent the leakage of high concentration reject water from concentrate compartments to the low concentration product water in the dilute compartments, when operational and design requirements require high pressure in the concentrate compartments. In a preferred embodiment, the inventive spacer includes gasketed edges which are of the same thickness all around the holes of the spacer, with a mesh body made up of woven strands of non-conductive materials.

Definitions—As defined herein, the terms “ion” or “ions” refer to an atom or molecule with a net electric charge due to the loss or gain of one or more electrons. In electrolytes, ions are hydrated ions which means that they are covered by a shell of water molecules. The amount of charge of an ion depends on the number of electrons lost or gained. For any ion missing or gaining one electron, the net charge is equals to that of an electron, equal to 1.60217662×10⁻¹⁹ Coulombs. This results in the fact that one mole of electrons is equivalent to Avogadro's number (6.02214×10²³) of electrons or 96,485.3 Coulombs.

As used herein, the terms “electrolyte” and “electrolyte solution” are interchangeable. The principals disclosed herein are therefore applicable to any solute or chemically defined salt or salt mixture dissolved in any polar liquid, wherein the result is the formation of an electrolyte solution. Therefore, when referring to ion-containing or salty waters, irrespective of the variety and concentration of the salts present in unit volume of the liquid, it is to be interpreted as to mean and include an electrolyte solution. As such the term water can mean any polar solvent and the term salt can mean any solute which together with a polar solvent forms an electrolyte solution.

As used herein the terms “Ion Exchange Membrane” and “Ion Selective membrane” refer to semi-permeable membranes which can function as either cation-selective or anion-selective membranes; such terms are interchangeable when used in this document.

As used herein the terms “electroactive media” and “ion exchange resin beads” are interchangeable and may include any shapes or forms as long of they can perform the intended function of conducting ions in a sparingly conductive solution under the influence of an electric field, while maintaining sufficient mechanical integrity. Many types of electroactive media can be used to define a lower resistance path for ion flow in electrolytes acted upon by an electric field. The most common type is in the form of ion exchange resin beads, but electroactive media can also be in the form of beads bonded to one another by a bonding agent, or in the form of fabrics, and depending on the specifics of a design can be mixed anion and cation exchange beads or singular polarity bead layers filling one compartment or distinct sections of both types of resin beads in a single compartment.

As used herein, “gasketing material” used in manufacture of these invented spacers are meant to define any elastomer or adhesive gel or liquid that can be used to cover a plastic mesh while also penetrating it, which once cured can form a sealing gasket thereon. Gasketing materials include one or two-part silicone rubber, neoprene, nitrile, PTFE, rubber, and various polymers such as polychlorotrifluoroethylene. The gasketed edge disclosed herein can be cured by the use of heat, pressure, chemical additives acting as catalysts or ultraviolet light, or combinations thereof.

The terms “electrodeionization” and “electrodialysis” as they apply to specific processes used are technically different. As noted above, electrodeionization devices are typically used for production of higher purity products from higher purity feeds while electrodialysis systems are used to produce water for such uses as for human consumption or for agriculture from brackish waters and seawater. Further, electrodeionization systems may be distinguished from electrodialysis systems by incorporation of specific voluminous spacers (or separators) placed between the ion-selective membranes while electrodialysis devices typically use rather thin spacers made up a plastic mesh. Such spacers, as they apply to the present invention and electrodeionization devices, are typically filled with electroactive media such as ion exchange resin beads, which facilitate ion flow in the low conductivity input and sparingly conductive high purity output product which is generated in the diluate compartments. Further, while electrodialysis systems are typically used for input solutions having 1000 mg/liter and higher salt content, such as brackish water and seawater, electrodeionization systems typically are used for input solutions already having a low salt content, such as aqueous salt solutions that are the product of passing through one or more reverse osmosis systems. Typically, these feeds have conductivities of less than 50 μS/cm corresponding to about 18 to 20 ppm equivalent NaCl.

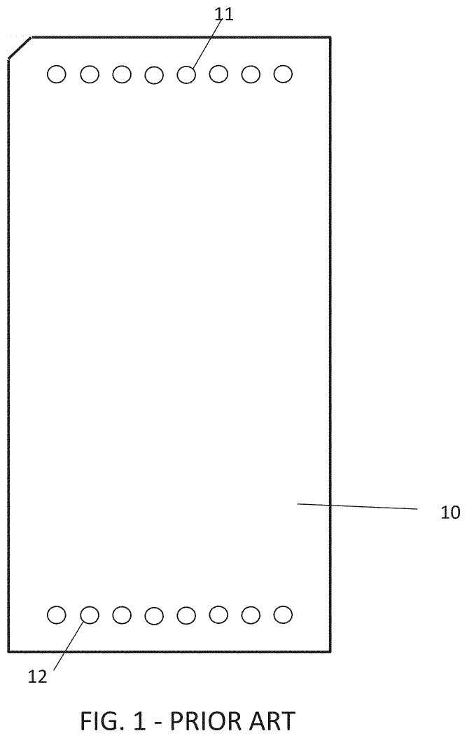

Prior Art Stacks and Spacers—FIGS. 1-6 illustrate typical prior art stack components used in typical prior art electrodialysis or electrodeionization stacks. Specifically, FIG. 1 shows a single ion exchange membrane sheet 10, including a plurality of equal sized holes 11 near the top end and the same number of equal sized holes 12 near the bottom of the sheet. This sheet can be either an anion exchange membrane or a cation exchange membrane.

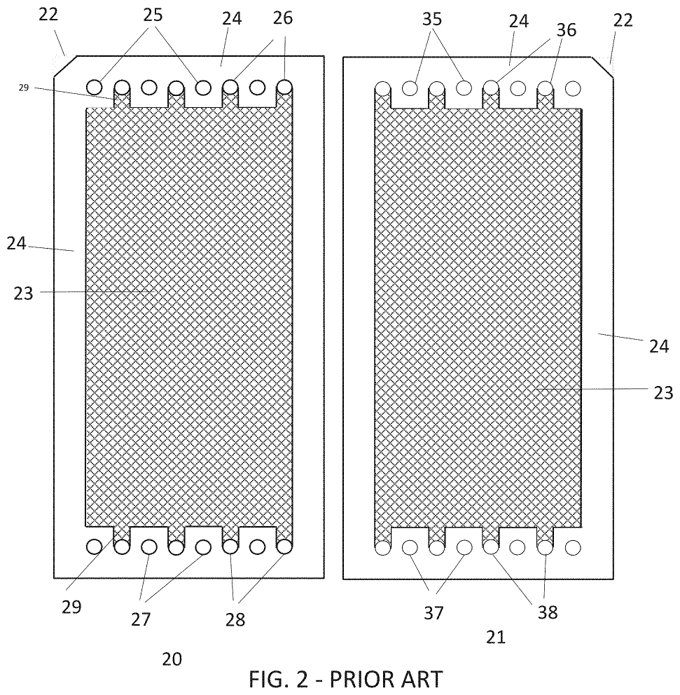

FIG. 2 shows two typical prior art spacers 20, 21, for use in electrodialysis stacks, both of which are substantially identical, with spacer 21 being the spacer 20 flipped or turned over along its longer side, as identified by the positions of the triangular cuts 22. Both spacers 20, 21 are made up of a thin plastic mesh 23 (usually less than one millimeter thick), wherein an outline pattern around the perimeter of the sheet, preferably made of a rubber-like compound such as silicon rubber, is infused on the spacer sheet surrounding the plastic mesh 23, forming a gasket 24 structurally connected to the central mesh 23. The outline pattern or gasket 24 covers all the periphery of the spacer on both sides of the spacer sheet, with specific patterns around the punched holes 25 and 26 on the top and holes 27 and 28 on the bottom of spacer 20, and around the punched holes 35 and 36 on the top and holes 37 and 38 on the bottom of spacer 21. That is, holes 26 and 28 of spacer 20, as well as holes 36 and 38 of spacer 21 shown in FIG. 2 are structurally and hydraulically connected to the central mesh 23 via extensions 29. In contrast, holes 25 and 27 of spacer 20, as well as holes 35 and 37 of spacer 21, are structurally and hydraulically isolated from the central mesh 23.

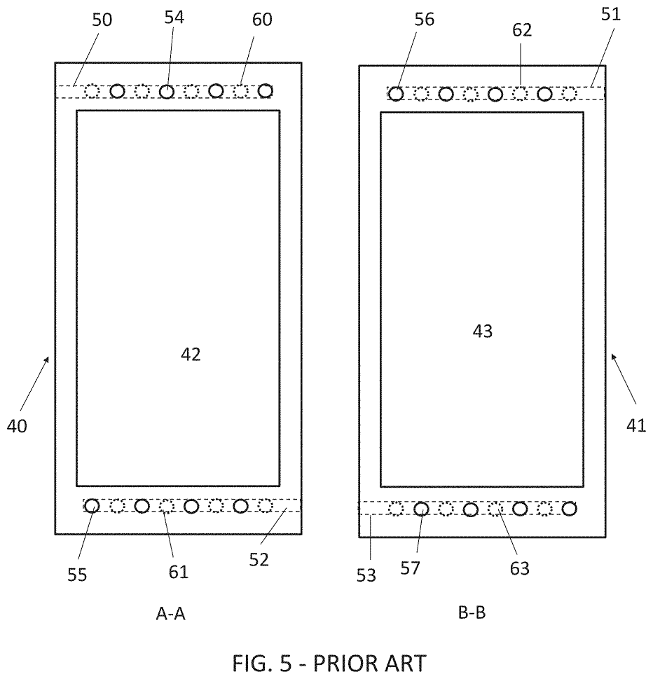

In typical electrodeionization stacks the gasketed spacer edges are rather thick, typically several millimeters, such that they can also allow for placement of electroactive media (resin beads) between the membranes. The dimensions and location of the plurality of holes 25 to 28 of spacer 20, and holes 35 to 38 of spacer 21 shown in FIG. 2, are intended to perfectly match with holes 11 and 12 presented in FIG. 1. The opposite orientation of spacers 20 and 21 provides that when feed lines, such as water conveyance holes 54 or 57 as shown in FIG. 5, connect to spacer holes 26 and 28 on spacer 20, water flows in the compartment formed between two adjacent membranes housing this spacer and can not enter the next compartment housing the next spacer 21 as the gasket material around spacer holes 25 and 27 form a seal between this spacer and the two membranes adjacent to it. It is also noted that in some designs the shape of the rectangular extensions 29 is trapezoidal, with the larger base connected to the open mesh area 23 and the smaller base fitting the holes.

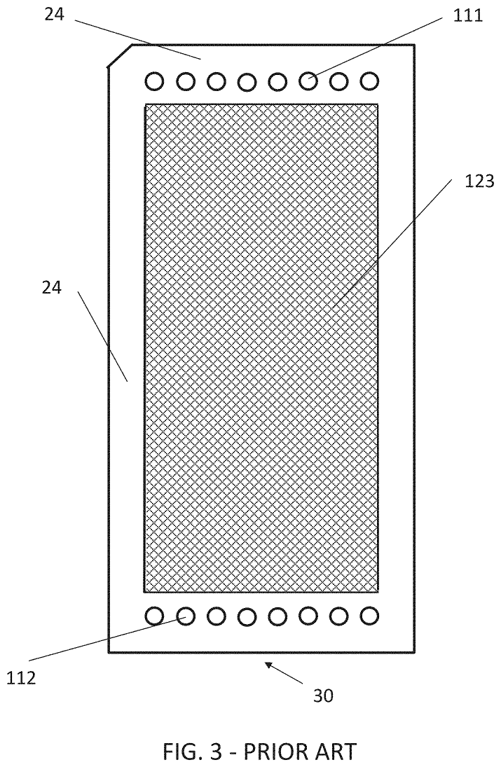

FIG. 3 presents an end spacer 30, wherein the central mesh 123 is the same as central mesh 23 in FIG. 2, but, in contrast to the gasketed edge 24 of the spacers 20, 21 shown in FIG. 2, the infused gasketed edge 24 of the end spacer 30 structurally and hydraulically isolates all the water conveyance holes 111, 112 on top and bottom of the end spacer 30 from the central the central mesh 23. With the use of these end spacers 30, and with an ion selective membrane adjacent to it on the stack side of the end spacer, the contents of electrode compartments can be hydraulically isolated from the water flow regimes of the dilute compartments and the concentrate compartments within the stack. As noted above, in all electrodialysis and electrodeionization cells wherein it is intended to separate the electrode compartment solutions from the feed, the dilute solutions, and the concentrate solutions, the stacks have an “end spacer” (e.g. end spacer 30) on each side of the stack that separates the stack from the endplates.

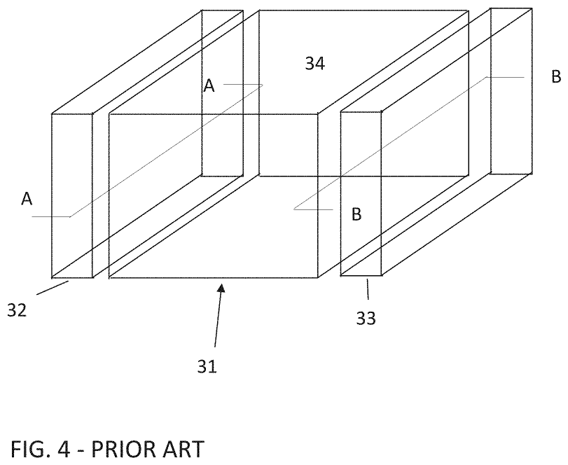

All of the other spacers in the stack which are not end spacers are simply referred to herein as “spacers” such as those represented by spacers 20, 21 in FIG. 2. If a stack, following the end spacer 30, begins at one end of the stack with a cation exchange membrane, then this membrane may be followed by a spacer 20, in turn followed by an anion exchange membrane, and then another spacer 21. This pattern can then repeat until the end spacer 30 at the other end of the stack is reached. Similarly, if a stack starts with an anion exchange membrane, then this membrane can be followed by a spacer in turn followed by a cation exchange membrane and then another spacer oriented in reverse. This pattern then also repeats. In both of the repeating patterns described above, the orientations of spacers 20 and 21 placed in adjacent compartments between ion exchange membranes are opposite of one another. That is, if the spacer following the first membrane is oriented like spacer 20 in FIG. 2 with the triangular corner cut on the left side, then the spacer following the next membrane, which can be an anion exchange membrane, can be oriented like spacer 21 in FIG. 2 with the triangular cut on the right side. Such stacks are then placed between the two endplates (e.g. 32, 33 of FIG. 4), which also house the electrodes and input and output water conveyance lines.

FIG. 4 shows a block diagram 31 of a typical prior art electrodialysis/electrodeionization cell in which blocks 32 and 33 are the two endplates, and block 34 represents the stack. In this figure two directional views A-A and B-B are also shown representing the views towards endplate 32 and endplate 33, respectively. FIG. 5 presents two prior art electrodialysis and/or electrodeionization endplates 40 and 41, which correspond to views A-A and B-B of FIG. 4 respectively, wherein the dashed lines 50 on top and 52 at the bottom of endplate 40, and dashed lines 51 on top and 53 at the bottom of endplate 41 indicate the water conveyance passages (feed input or output stream) on these end plates that are drilled from the sides of these rather thick (usually 5 to 20 cm thick) end plates. The first end plate 40 is located on one end of the stack (34, of FIG. 4), and the second end plate 41 is placed on the other end of the stack. The connection and valves on these water conveyance passages 50 to 53 are not shown. There are also two cavities 42 and 43 withing the endplates 40 and 41, respectively, which house electrodes that are not shown, but are well known to those who practice the art. Water conveyance holes 54, 55, 56 and 57 are at the top and bottom of endplates 40 and 41, and connect to water conveyance passages 50, 51, 52 and 53 entering from the sides of the plates as shown. In FIG. 5, water conveyance holes 54 to 57 correspond to every other of hole 11 and 12 on membranes in FIG. 1, with the position of the remaining membrane holes indicated as dashed circles by numerals 60, 61, 62 and 63.

Input water coming into the cell from holes/passages 54 on endplate 40 will flow through the spacer-filled compartment between the first ion exchange membrane and the second ion exchange membrane, and repetition of the same with spacers oriented like spacer 20 within the stack and leave the cell from holes/passages 57 on end plate 41. Similarly, when another stream of input feed water enters through holes/passages 56 on end plate 41, it will flow through the spacer-filled compartment between the next two membranes, and repetition of the same with spacers oriented like spacer 21 and exit the stack through holes 55 on end plate 40. This means that two sets of compartments are defined in each stack of a cell, each being fed by a separate feed stream, and they are hydraulically isolated from one another, as is well-known by the practitioners of this art.

The result of the above mentioned patterns of flow will be that as these two separate streams flow through the cell, and when the electrodes are connected to a DC current power supply, the electric field generated and passing through the stack can drive the positive and the negative ions in opposite direction of each other, and by interactions with ion exchange membranes result in the formation of dilute compartments adjacent to concentrate compartments, as is also well known in the art. These separate streams are then drawn out continuously or intermittently (e.g. batch operation) as the process proceeds and more concentrated feed solution is supplied. Flow directions in one or both of these compartments can also be put in reverse, such that the feed can enter from the bottom and leave from the top of the stack for one or both flows. It is also noted that the feed solutions for the electrode compartments may be distributed into and out of the electrode compartments through lateral conveyance passages connecting to them (not shown), and using the end spacers shown in FIG. 3 may be kept separate from the feed flows forming the dilute streams and the concentrate streams.

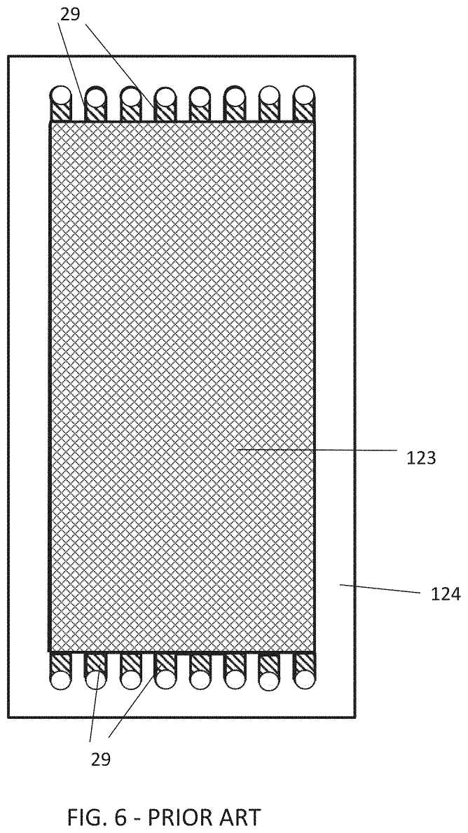

With a view to FIG. 4, it is pointed out that the endplates 32, 33 (40, 41 in FIG. 5) support the stack all around the edges, that is, the area outside the electrode cavities 42 and 43 in FIG. 5. These endplates 32, 33 are then compressed against each other and the stack 34, typically by metallic support plates (not shown), and pulled towards one another by a frame system including nuts and bolts (also not shown). Sometimes the bolting system and the endplates are combined, eliminating the need for external support plates. The compression of the stack 34 then allows the gasketed parts such as gasketed edge 24 in FIG. 2 to seal the stack and prevent any leaks to the outside. In this configuration, the endplates and their support plates compress the ion exchange membranes and the spacers outside the central mesh area of the spacer. This supported/compressed area also covers extensions of the mesh identified by numeral 29 in FIG. 2. Since the endplates form rather rigid structures compared to the stack, it can be assumed that there will be uniform compression of the stack over the area supported by the endplates. However, given the fact that the extensions 29 of the spacer mesh are slightly thinner than the gasketed edge 24 of the spacers 20 and 21, it follows that the stress imposed on the extensions of the mesh 29 can be lower than their adjacent gasketed areas. In other words, if we consider two compressed membranes and their related spacers, the thickness of the combined two spacers and two membranes all around the edges will be equal to thickness of the two membranes plus the gasketed thickness of the two spacers. But in the areas identified by numeral 29, this thickness can be equal to the thicknesses of the two membranes plus the thickness of the gasketed edge on one spacer and the thickness of un-gasketed bare mesh on the other spacer. This means that the stack thickness can be the same all around the gaskets and membranes, but the areas identified by numeral 29 are thinner, and therefore compressed less. These areas of lower compressive stress 29 are shown in FIG. 6 (showing two spacers 20 and 21 one on top of the other) that correspond to the same on FIG. 2.

Lower compressive stress on the extensions 29 of the mesh in FIG. 2 causes the seal between the compartments in the stacks to be weaker at these points, compared to the adjacent gasketed areas. Therefore, when an electrodialysis cell with the prior art spacers shown in FIG. 2 is operated with different flow feed pressures (pressure differential) between the dilute and the concentrate feeds (which is often desired in order to accomplish high recovery of dilute product water), product water can leak from the dilute compartments into the adjacent concentrate compartments because this increased pressure differential. Observations by this inventor on a number of stacks that used the prior art spacers have confirmed this. One of the test stacks used for this observation employed one hundred (100) membranes that were 0.35 mm thick and 30 cm by 50 cm in plan area, and spacers that were 0.355 mm thick at the edge (gasketed edge 24 in FIG. 2) and 0.35 mm thick at the thinner bare mesh parts of the spacers (areas 23 and 29 in FIG. 2). When pressurizing one set of compartments by about one bar of pressure, very visible leaks of several milliliters per second were observed.

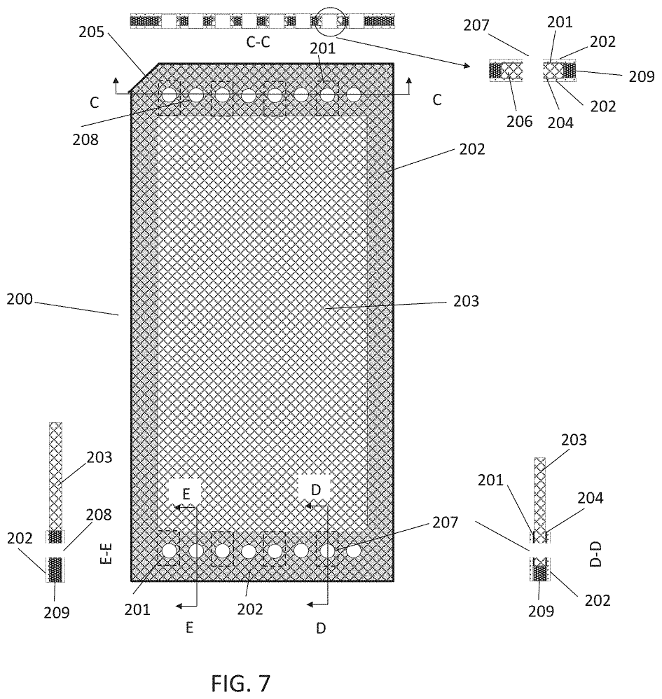

Improvements—The present invention is an improvement over prior art spacers because it can reduce and/or prevent leakage of output product (e.g. purified water) from the dilute/product compartments to the concentrate compartments, resulting in higher product water recovery and reduced energy consumption. FIG. 7 illustrates one embodiment of an inventive spacer 200 for use in electrodialysis and electrodeionization cells, including three sectional views C-C, D-D and E-E.

In order to explain the structure of this spacer, its manufacturing steps are presented. The spacer 200 begins as a simple plastic mesh sheet between 0.1 mm and 2.0 mm thick, more preferably between 0.5 mm and 1.0 mm thick. Looking at FIG. 7, the plastic mesh sheet is shown laying flat with a “first” side facing up, in which its “top” end or portion can be identified by the position of a triangular cut 205 at the left corner. In contrast, the “bottom” end or portion of the sheet does not have a triangular cut, instead having right angles at each corner. The sheet 200 can also be flipped or turned over (see, e.g., FIG. 2), so that a “second” side (i.e. previously the underside) of the sheet is exposed in which the triangular cut 205 is now at the top right corner. The spacer 200 is shown in FIG. 7 with its first side facing up such that its top portion's triangular cut 205 is at the left corner.

Initially, a plurality of lengths of tape 201 are arranged over the location of every other water flow hole, at both the top and the bottom portions of the flat plastic mesh spacer sheet 200. For example, as illustrated in FIG. 7, the location of water flow holes 207 are covered by tape 201, and the location of water flow holes 208 are un-taped. Next, gasketed edge 202 is added to the plastic mesh sheet. Specifically, gasketing material capable of being used in the form of a liquid or gel is infused or otherwise applied at the outside edges of the flat plastic mesh spacer sheet 200, as illustrated. The gasketing material can be applied, for example, by silk-screening techniques using materials such as silicon rubber, nitrile rubber, plastic polymers, or other similar material.

Gasketed edges for spacers are known in the art for providing means for the independent flow of feed water into and out of the dilute compartments and the concentrate compartments, e.g. via water flow holes 207, 208. However, the inventor has found that appreciable leaking from the dilute compartments to the concentrate compartments occurs when an increasing differential pressure is applied to prior art gasketed spacers. As noted above, the practice of increasing the pressure differential between the dilute compartments and the concentrate compartments is desirable during electrodialysis and electrodeionization process, in order to achieve high recoveries of output product such as purified water. It has been discovered that this leaking phenomenon can be prevented using the inventive spacer disclosed herein.

During application, care is taken to create a gasketed edge 202 around the perimeter of the plastic mesh sheet, which cover the lengths of tape 201 and the water flow holes 207, 208, while leaving a central open plastic mesh area 203 bounded by the inward edges of the gasketing edge and the lengths of tape 201. See FIG. 7. The gasketing material that makes the gasketed edge 202 preferably penetrates the full thickness of the plastic mesh as identified by numeral 209 on FIG. 7. However, there is no in-depth penetration of the plastic mesh by the gasketing material in the area covered by the lengths of tape 201 at the location of flow holes 207. Therefore, the “connecting flow paths” 206 of the plastic mesh sheet, that is, the tape-covered areas connecting the water flow holes 207 to the open central mesh area 203, will remain unaffected by the gasketing material, while the top of the lengths of tape 201 and the rest of the gasketed edge 202 are fully covered by the gasketing material. The connecting flow paths 206 therefore structurally and hydraulically connect the water flow holes 207 to the central mesh area 203. This gasketing material application step is performed until a uniform thickness of gasketing material is deposited on the first side of the spacer mesh at the gasketed edge 202.

Once the gasketing material is applied as described above to the first side of the spacer, and once the material has sufficiently cured/dried, the spacer sheet 200 can now be turned over to expose the “second” side (i.e. so that the triangular cut 205 is now at the right top corner), and an additional plurality of lengths of tape 204 are arranged over the location of water flow holes 207 at both the top and the bottom portions of the sheet 200, at the same positions as the plurality of lengths of tape 201 on the first side of the sheet. These additional lengths of tape 204 are preferably as thin as possible to minimize differing compressibility at these locations, and depending on operational manufacturing requirements can include a thin layer of glue on the side placed on the mesh to help their adherence to the mesh during application of the liquid gasketing material. The inventor has found that Scotch® tape with a thickness of about 0.04 mm can be used for prototype manufacturing of the inventive spacer 200.

Once the additional lengths of tape 204 are applied over the location of water flow holes 207 at the second side of the plastic mesh sheet, the application of gasketing material covering the same gasketed edge 202 is then repeated. During this application step, the gasketing material can be deposited with the same or differing thickness as compared to the first side. Once the gasketing material on the second side of the spacer is also cured/dried, the water flow holes 207 covered by tape at each taped location and the water flow holes 208 at each un-taped location are then punched, drilled, or otherwise cut out. This will result in a spacer which, when used in either electrodialysis or electrodeionization cells, can allow the flow of feed solution to enter and exit the central mesh area 203 from the connecting flow paths 206 between the water flow holes 207. The full thickness of the gasketed edge 202 can be the same throughout the perimeter of the spacer, and can therefore cause uniform compression and provide uniform compressive stress around the water flow/conveyance holes, which can facilitate better sealing between adjacent compartments and prevent leakage.

For use in electrodeionization systems, it is preferred that the open central plastic mesh portion 203 has a thickness of between 0.1 mm and 2.0 mm, more preferably between 0.5 mm and 1.0 mm thick, while the thickness of the gasketing material deposited at the gasketed edge 202 is between 0.5 mm and 8.0 mm thick, preferably between 1.0 mm and 5.0 mm thick. The greater thickness of the gasketed edge 202 compared to the thickness of the open central portion 203 is intended to allow for placement of electroactive media on the spacer, as described above. As such, the thickness of the gasketed edge 202 can be varied depending on the desired thickness of the added media layers. In addition, the thickness of the gasketing material that is deposited on the first side of the spacer can be different than that deposited on the second side of the turned over spacer. This may be preferable, for example, if the project calls for placement of resin beads on the “thicker” side of the spacer, during the assembly of the stack.

Alternatively, these invented spacers could be manufactured by the use of a water-soluble paste, such as sodium bicarbonate thick paste in place of the tapes. Such paste could be placed in the future location of the holes where in the pervious embodiment thin tapes were placed. Then the gasket material is applied with a uniform thickness on both sides of the spacer mesh as before. After punching and/or drilling the holes, the spacers could be placed in water allowing the water-soluble paste to dissolve, leaving the mesh in these locations free and open allowing water flow through them.

Test Results—A number of mesh samples with thicknesses ranging from 0.2 mm to 0.5 mm have been tested with 14 mm wide and 0.04 mm thick scotch transparent tape placed on the mesh. The tape covered area and the area adjacent to it were then covered with a thin layer commercially available silicon rubber paste (KWIK SEAL ULTRA) using a lab spatula. After a few hours each mesh sample was flipped, and the same area was also covered with similar tapes and were also covered with silicon rubber. After 24 hours 0.5 cm in diameter holes were punched in the taped as well as untapped sections of the meshes used. Each of the parts were then placed between two 0.4 mm thick silicone gasket sheets where the top one had a hole matching the hole on each mesh and the other one had no holes. These sections were then tested for their hydraulic behaviour using a specialty hydraulic testing device. This device allowed for flow of water through a sealed 12.5 mm (½ inch) circular passages edges to the punched hole locations and could seal perfectly against the top gasket. Water at negligible pressure easily flowed out of the uncovered edges of the taped sections while the untapped sections were perfectly sealed for test pressures of up to 0.7 Bar. These tests showed that the proposed structure of this invented spacer could deliver the required functionality described above.

The inventive spacer described herein provides a means in which product water wastage due to leakage between the dilute compartments and the concentrate compartments of electrodialysis and electrodeionization cells can be reduced or eliminated, resulting in higher product water recovery and reduced energy consumption. While the present invention has been illustrated by the description of embodiments and examples thereof, it is not intended to restrict or in any way limit the scope of the appended claims to such details. Additional advantages and modifications will be readily apparent to those skilled in the art. Accordingly, departures may be made from such details without departing from the scope of the invention.

What is claimed is:

1. A spacer for use in electrodialysis and electrodeionization systems, the spacer comprising:
a) a plastic mesh sheet including a top end, a bottom end, a first side, and a second side; and
b) a gasketing edge structurally connected to the plastic mesh sheet, the gasketing edge comprising:
i) gasketing material applied to the outside perimeter of the first side and the second side of the plastic mesh sheet; and
ii) a plurality of water flow holes arranged within the gasketing edge at the top end and at the bottom end of the plastic mesh sheet;
c) a central mesh area bounded by the gasketing edge, wherein a first half of the plurality of water flow holes are structurally and hydraulically connected to the central open area;
d) a plurality of connecting flow paths structurally and hydraulically connecting the first half of the plurality of water flow holes to the central mesh area,
wherein the thickness of the applied gasketing material is uniform on both the first side and the second side of the plastic mesh sheet so that the gasketing edge provides uniform compressive stress around the water flow holes, thereby preventing leakage.

2. The spacer of claim 1, wherein the thickness of the gasketed edge is greater than the thickness of the central mesh area to allow for placement of electroactive media on the spacer.

3. The spacer of claim 2, wherein the central mesh area has a thickness of between 0.1 mm and 1.0 mm, and wherein the thickness of the gasketing material deposited at the gasketed edge is between 1.0 mm and 5.0 mm.

4. The spacer of claim 1, wherein the thickness of the gasketing material that is deposited on the first side of the plastic mesh sheet is different than the thickness of the gasketing material that is deposited on the second side of the plastic mesh sheet.

5. The spacer of claim 1, wherein the gasketing material comprises materials such as silicon rubber, nitrile rubber, plastic polymers, or other similar material.

6. A process for the manufacture of a spacer for use in electrodialysis and electrodeionization systems, the spacer comprising: a plastic mesh sheet including a top end, a bottom end, a first side, and a second side; and a gasketing edge structurally connected to the plastic mesh sheet, the gasketing edge comprising: a gasketing material applied to the outside perimeter of the first side and the second side of the plastic mesh sheet; and a plurality of water flow holes arranged within the gasketing edge at the top end and at the bottom end of the plastic mesh sheet; a central mesh area bounded by the gasketing edge, wherein a first half of the plurality of water flow holes are structurally and hydraulically connected to the central mesh area; a plurality of connecting flow paths structurally and hydraulically connecting the first half of the plurality of water flow holes to the central mesh area, wherein the thickness of the applied gasketing material is uniform on both the first side and the second side of the plastic mesh sheet, the process comprising the steps of:
a) placing one of a first plurality of lengths of tape over the location of every other water flow hole at both the top end and the bottom end of the first side of the plastic mesh sheet;
b) applying the gasketing material to the outside perimeter of the first side of the plastic mesh sheet while not applying the gasketing material to the central mesh area;
c) curing the applied gasketing material to the first side of the plastic mesh sheet;
d) placing one of a second plurality of lengths of tape over the location of every other water flow hole at both the top end and the bottom end of the second side of the plastic mesh sheet, and at the same positions as the first plurality of lengths of tape placed on the first side of the plastic mesh sheet;
e) applying the gasketing material to the outside perimeter of the second side of the plastic mesh sheet while not applying the gasketing material to the central mesh area;
f) curing the applied gasketing material to the second side of the plastic mesh sheet; and
g) punching out the plurality of water flow holes.

7. The process of claim 6, wherein the gasketing material is applied in the form of a liquid or gel.

8. The process of claim 6, wherein the gasketing material penetrates the full thickness of the plastic mesh sheet, and wherein there is no penetration of the plastic mesh by the gasketing material in the area covered by the lengths of tape.

9. The process of claim 6, wherein the steps of applying the gasketing material are performed until a uniform thickness of gasketing material is deposited on the outside perimeter of the plastic mesh sheet.

10. The process of claim 6, wherein the steps “a” and “d” are replaced by placing a water soluble paste in the location of every other water flow hole at both the top end and the bottom end of the first side of the plastic mesh sheet and washed away after step “g” by placing the spacer in water and allowing the water soluble paste to dissolve and wash away.

11. The process of claim 6, wherein the plurality of lengths of tape includes a layer of glue to aid in their adherence to the mesh during application of the gasketing material.

12. The process of claim 6, wherein the gasketing material deposited on the second side of the spacer has a different thickness as compared to the first side.

13. The process of claim 6, wherein the thickness of the gasketed edge is the same throughout the perimeter of the spacer, and can therefore cause uniform compression and provide uniform compressive stress around the water flow/conveyance holes, which can facilitate better sealing between adjacent compartments and prevent leakage.

14. The process of claim 6, wherein the gasketing material is applied in the form of a liquid or gel.

15. The process of claim 6, wherein the gasketing material comprises materials such as silicon rubber, nitrile rubber, plastic polymers, or other similar material.

16. An improved spacer for preventing leakage between stack compartments in an electrodialysis or electrodeionization system, the system comprising: a stack of alternating pairs of ion exchange membranes, each ion exchange membrane creating a concentrate compartment on one side and a dilute compartment on the other side when the system is filled with a feed solution and acted upon by a direct current; a first electrode housed in a first endplate positioned on one side of the stack; a second electrode housed in a second endplate positioned on the other side of the stack; a plurality of input and output passages leading into and out of the endplates and the stack; and a direct current electric power supply for establishing a potential difference between the first electrode and the second electrode to cause the passage of electric current through the feed solution,
wherein the improved spacer comprises:
a) a plastic mesh sheet including a top end, a bottom end, a first side, and a second side; and
b) a gasketing edge structurally connected to the plastic mesh sheet, the gasketing edge comprising: gasketing material applied to the outside perimeter of the first side and the second side of the plastic mesh sheet; and a plurality of water flow holes arranged within the gasketing edge at the top end and at the bottom end of the plastic mesh sheet;
c) a central mesh area bounded by the gasketing edge, wherein a first half of the plurality of water flow holes are structurally and hydraulically connected to the central open area;
d) a plurality of connecting flow paths structurally and hydraulically connecting the first half of the plurality of water flow holes to the central mesh area,
wherein each pair of ion exchange membranes has the improved spacer positioned between the membranes, wherein the thickness of the applied gasketing material is uniform on both the first side and the second side of the plastic mesh sheet so that the gasketing edge provides uniform compressive stress around the water flow holes, thereby preventing leakage between the stack compartments, reducing output product loss from leakage, and reducing energy consumption per unit volume of output product.

17. The improved spacer of the electrodialysis/electrodeionization apparatus of claim 16, wherein the thickness of the gasketed edge is greater than the thickness of the central mesh area to allow for placement of electroactive media on the spacer.

18. The improved spacer of the electrodialysis/electrodeionization apparatus of claim 17, wherein the central mesh area has a thickness of between 0.1 mm and 1.0 mm, and wherein the thickness of the gasketing material deposited at the gasketed edge is between 1.0 mm and 5.0 mm.

19. The improved spacer of the electrodialysis/electrodeionization apparatus of claim 16, wherein the thickness of the gasketing material that is deposited on the first side of the plastic mesh sheet is different than the thickness of the gasketing material that is deposited on the second side of the plastic mesh sheet.

20. The improved spacer of the electrodialysis/electrodeionization apparatus of claim 16, wherein the gasketing material comprises materials such as silicon rubber, nitrile rubber, plastic polymers, or other similar material.
